(19) United States
(12) Patent Application Publication
(10) Pub. No.: US 2005/0254512 A1
(43) Pub. Date: Nov. 17, 2005

(54) Signal processing unit with serial time multiplex connections between signal processing and control means

(76) Inventor: Stefan Schandl, Wien (AT)

Correspondence Address: Siemens Corporation;Intellectual Property Department, 170 Wood Avenue South, Iselin, NJ, 08830, US

(21) Appl. No.: 10/510,974

(22) PCT Filed: Mar. 24, 2003
(86) PCT No.: PCT/EP03/03039

§ 371 Date: May 4, 2005

(30) Foreign Application Priority Data
Apr. 9, 2002 (EP) 012007908.3

(51) Int. Cl. H04B 7/212

(52) U.S. Cl. 370/442; 370/498

(57) ABSTRACT

The invention relates to a signal processing unit, in particular for a telecommunication system, comprising means for digital signal processing, means for storage of data and control means, whereby the means for digital signal processing and the control means are connected to each other by means of serial time multiplex connections. A signal processing unit with particularly wide applications, in particular for signal processing tasks in digital communication systems, is thus achieved.

### CROSS REFERENCE TO RELATED APPLICATIONS

This application is the US National Stage of International Application No. PCT/EP03/03039, filed Mar. 24, 2003 and claims the benefit thereof. The International Application claims the benefits of European application No. 012007908.3 filed Apr. 9, 2002, both of the applications are incorporated by reference herein in their entirety.

### FIELD OF INVENTION

The invention relates to a signal processing unit, in particular for a telecommunication system, comprising means for digital signal processing, means for storage of data and control means.

### BACKGROUND OF INVENTION

Modern digital telecommunication systems must handle a range of signal processing tasks. These tasks include echo compensation, dial pulse identification and dial tone identification, as well as voice recognition, voice storage, voice compression and voice synthesis in connection with automatic information systems.

Due to the high computational effort—to be expended in real time—which is associated with this multitude of signal processing tasks, such tasks have hitherto been handled using function-specific modules. In particular, the retrofitting of network elements with these functionalities is a logistically intensive task.

### SUMMARY OF INVENTION

The object of the invention, therefore, is to provide a signal processing unit of the type mentioned in the introduction, which can be used for various digital signal processing tasks.

This object is achieved according to the invention by a signal processing unit in which the means for digital signal processing and the control means are connected to each other by means of serial time multiplex connections. The signal processing unit according to the invention can be used to resolve all the usual signal processing tasks to be carried out, such as echo compensation, dial pulse identification and dial tone identification, as well as voice recognition, voice storage, and voice synthesis in connection with automatic information systems.

It is advantageous if the serial time multiplex connections are implemented as a PCM 30 system. The PCM 30 system is a digital transmission system that allows the simultaneous transmission of up to 32 voice channels. This system is internationally standardized (except for the U.S.A. where the number of voice channels is 24) and forms the basis for all digital transmission systems with a higher number of channels.

Ideally, digital signal processors and/or echo suppression means are provided as means for digital signal processing. These are standard digital signal processing elements, which are suitably designed for these tasks, are available in large quantities, and are relatively inexpensive.

Furthermore, an embodiment in which the signal processing unit is implemented as a separate module is advantageous as this makes the signal processing unit very easy to integrate into systems.

In a particularly advantageous application, the signal processing unit is implemented as a separate module of an exchange of a digital switching system.

### BRIEF DESCRIPTION OF THE DRAWINGS

The invention is explained in greater detail with the help of diagrams. In, these, by way of example,

FIG. 1 shows the integration of a signal processing unit according to the invention into an exchange of a telecommunication network,

FIG. 2 shows the configuration of a signal processing unit according to the invention,

FIG. 3 is a detailed diagram showing the time multiplexing connections according to the invention, and

FIG. 4 is a diagram showing the external interfaces of the signal processing unit.

### DETAILED DESCRIPTION OF INVENTION

The signal processing unit VPU shown in FIG. 1 is a module which is plugged into slots of a trunk group UI-LTGN (also UI-LTGP) of a digital switching system, such as—for example—the EWSD digital electronic switching system from Siemens. The trunk groups form the interface between the subscriber lines and the switching network SN. As well as up to 4 signal processing units according to the invention, each trunk group UI-LTGN contains a group processor GP as the central control unit.

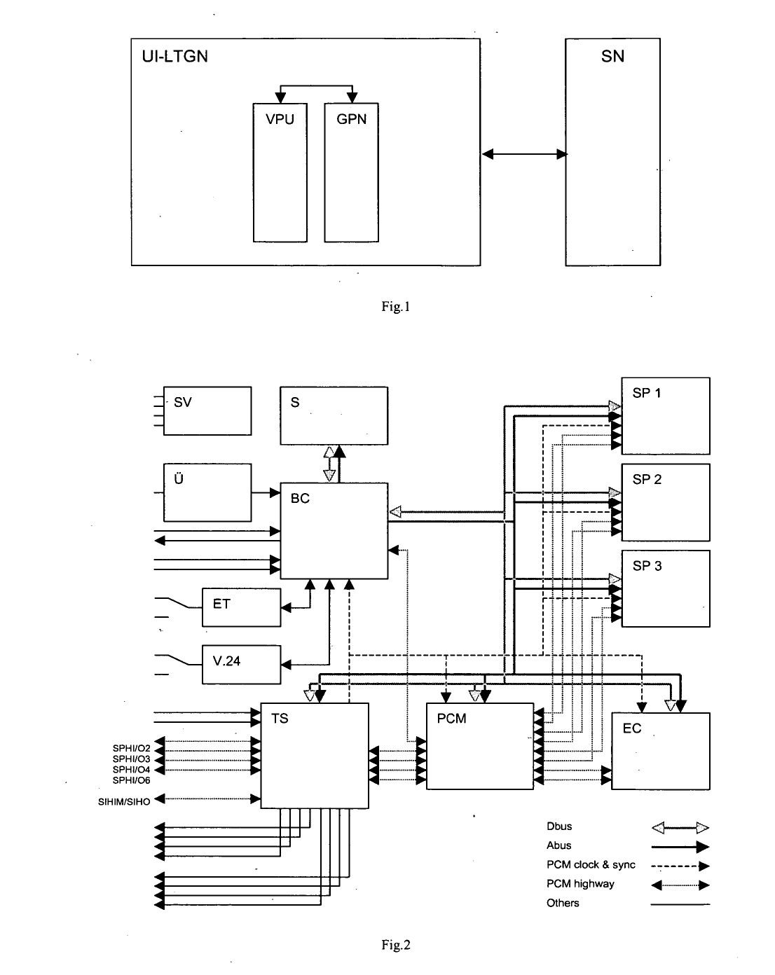

The construction of an inventive signal processing unit for the Siemens EWSD system is explained in greater detail with the help of FIG. 2. This signal processing unit incorporates as modules the power supply unit SV, main memory S, supervisory unit Ü, interface driver for Ethernet and V.24 ports, a clock supply TS, a control unit for the time multiplex connections PCM, module control unit BC, signal processors SP1, SP2, SP3 and an echo suppression unit EC.

The functional elements of the signal processing unit VPU are connected by means of a data bus Dbus, address bus Abus, time multiplex connections PCM clock&sync and PCM highway, and other control and signaling lines Others.

The power supply unit SV is based on a DC/DC converter unit, which converts the voltage of −48/−60 V which is present in the system, to the voltage of 3.3 V which is required by components of the signal processing unit VPU.

The supervisory unit Ü guarantees a defined startup of the signal processing unit VPU when the supply voltage is applied. It also supervises the level of the supply voltage and delivers a warning signal if the permitted values are not reached. The supervisory unit Ü can also be used for restarting the signal processing unit VPU during operation if necessary.

The Internet driver for Ethernet EN as per IEEE 802.3 is implemented with a “Fast Ethernet Controller” of type MPC860T from Motorola. The Ethernet interface of the signal processing unit VPU is primarily used for loading control programs for the function elements.

The RS232 port V.24 of the signal processing unit VPU, which is controlled by the processor of the module control unit BC, is used mainly for the tasks of error detection and monitoring (debugging and tracing).

Further user interfaces are provided for control purposes on the signal processing unit VPU, namely a JTAG interface for programming and LEDs for displaying the operating status.

The signals necessary for operating the signal processing unit VPU are derived from clocks in the trunk group by means of the clock supply TS.

The interaction of all function elements of the signal processing unit VPU is managed by means of the module control unit BC. The module control unit BC is implemented in the exemplary embodiment with a processor of the type “PowerQUICCprocessor MPC860T” from Motorola.

A permanent memory, which is implemented by means of EEPROMs, is provided for storing module-specific data. A microcontroller for controlling the startup of the processor is implemented in an additional permanent memory which is constructed from ROM or Flash storage elements.

32 Mbytes of SDRAM are provided as main memory for the processor.

Digital signal processors of type TMS320C6201 from Texas Instruments are used as signal processors SP1, SP2, SP3; these are equipped with DRAM or SDRAM storage elements each with a minimum storage capacity of 32 Mbytes.

The echo suppression unit EC is equipped so as to permit echo suppression up to a delay of 64 ms for all receive channels of the time multiplex connections. The echo suppression unit EC is controlled by the module control unit BC.

The signal processors are each connected via their host port interface to the module control unit, and via serial interfaces to the time multiplex connections PCM.

In addition to the storage elements of the individual function elements, a main memory S is provided which is implemented by means of Flash memory elements and incorporates up to 256 Mbytes of storage capacity.

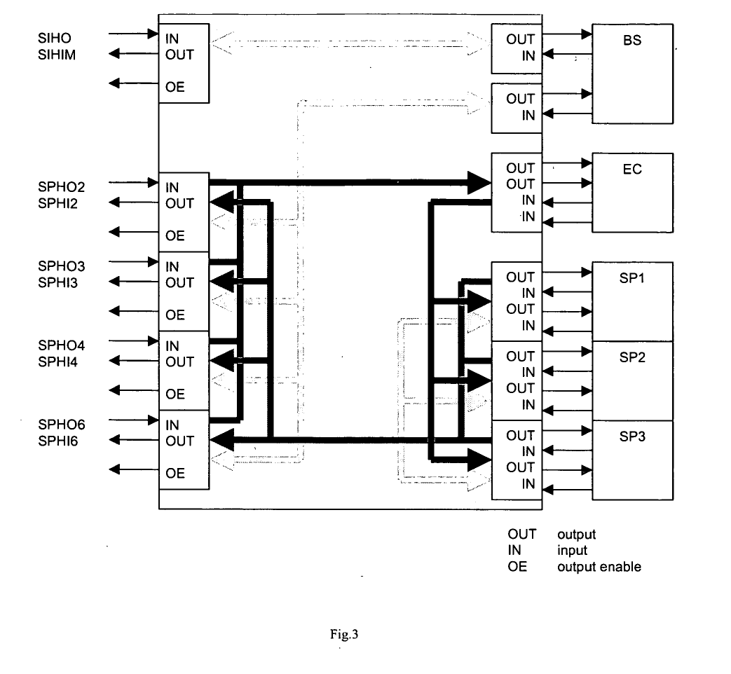

The control unit for the time multiplex connections PCM is explained in greater detail with the help of FIG. 3.

This shows, by way of example, a detailed representation of the time multiplex connections, according to the invention, between the function elements of the signal processing unit VPU: module control unit BC, signal processors SP1, SP2, SP3, echo suppression unit EC, and the interfaces SIHO, SIHIM, SPHI2 . . . SPHI6, and SPHO2 . . . SPHO6, which are predefined through the integration of the signal processing unit VPU into a trunk group UI-LTGN of a digital switching system.

These time multiplex connections are designed as PCM 30 connections with 32 telephone channels (SPHx) or 32 signal channels (SIHx).

The signaling channels of the time multiplex connections PCM are conducted directly via the signaling interface SIHO, SIHIM to a serial interface of the module control unit BS and via a further interface of the module control unit BS to control inputs of the driver elements of the telephone interfaces SPHI2 . . . SPHI6, and SPHO2 . . . SPHO6 of the signal processing unit VPU.

The signal processing unit VPU is connected to the telephone channels of the trunk group UI-LTGN of a digital switching system via the telephone interfaces SPHI2 . . . SPHI6, and SPHO2 . . . SPHO6. The telephone channels are conducted internally to interfaces of the signal processors SP1, SP2, SP3 and of the echo suppression unit EC.

This also means that unused channels of the time multiplex connections PCM, which are provided per se for telephone traffic, can be used for data exchange between the signal processors SP1, SP2, SP3.

By means of the embodiment described above, the signal processing unit VPU can now easily be adapted to each signal processing task by programming its function elements accordingly. In particular, the internal continuation of time multiplex connections PCM facilitates the efficient processing and forwarding of telephone data, thus enabling the most diverse requirements to be processed in real time.

Thus the system processing unit VPU could also conceivably be used as a voiceover IP gateway, i.e. as the interface between a conventional time multiplex telephone system and a computer network.

The task of such a gateway is to convert compressed voice data that has been transferred over a computer network, packet by packet, into pulse code-modulated voice data (PCM 30), and vice-versa. This gateway is therefore a complex network element and requires correspondingly efficient hardware and software. These demanding requirements are fulfilled by the signal processing unit thanks to its structure according to the invention.

1.-5. (canceled)

6. A signal processing unit, comprising:
a mechanism for digital signal processing; and
a control mechanism, wherein
the mechanism for digital signal processing and the control mechanism are connected by a serial time multiplex connection.

7. The signal processing unit according to claim 6, wherein the signal processing unit is used in a telecommunication system.

8. The signal processing unit according to claim 6, further comprising a mechanism for storing data.

9. The signal processing unit according to claim 6, wherein the serial time multiplex connection is implemented as a PCM 30 system.

10. The signal processing unit according to claim 7, wherein the serial time multiplex connection is implemented as a PCM 30 system.

11. The signal processing unit according to claim 8, wherein the serial time multiplex connection is implemented as a PCM 30 system.

12. The signal processing unit according to claim 6, wherein the mechanism for digital signal processing is a digital signal processor and/or a mechanism for echo suppression.

13. The signal processing unit according to claim 7, wherein the mechanism for digital signal processing is a digital signal processor and/or a mechanism for echo suppression.

14. The signal processing unit according to claim 8, wherein the mechanism for digital signal processing is a digital signal processor and/or a mechanism for echo suppression.

15. The signal processing unit according to claim 9, wherein the mechanism for digital signal processing is a digital signal processor and/or a mechanism for echo suppression.

16. The signal processing unit according to claim 6, wherein the signal processing unit is implemented as a separate module.

17. The signal processing unit according to claim 7, wherein the signal processing unit is implemented as a separate module.

18. The signal processing unit according to claim 8, wherein the signal processing unit is implemented as a separate module.

19. The signal processing unit according to claim 9, wherein the signal processing unit is implemented as a separate module.

20. The signal processing unit according to claim 12, wherein the signal processing unit is implemented as a separate module.

21. The signal processing unit according to claim 16, wherein the signal processing unit is implemented as a separate module of an exchange of a digital switching system.
